(19) United States
(12) Patent Application Publication
(10) Pub. No.: US 2004/0183502 A1
(43) Pub. Date: Sep. 23, 2004

(54) Rechargeable receiver

(76) Inventor: Kuo-Shu Cheng, Taipei (TW)

Correspondence Address: JOE NIEH, 18760 E. AMAR ROAD #204, WALNUT, CA, 91789, US

(21) Appl. No.: 10/392,421

(22) Filed: Mar. 19, 2003

(51) Int. Cl. H02J 7/00

(52) U.S. Cl. 320/108

(57) ABSTRACT

A rechargeable receiver for receiving the signal from a wireless transmitter of a computer peripheral device such as a keyboard or a mouse and has a built-in recharger for recharging the rechargeable batteries used in the computer peripheral device with the wireless transmitter.

The rechargeable receiver comprising a housing formed by the interface of a cover and a base to affix and enclose a circuit board with a signal receiver and a recharging circuit within the housing, a battery charger with a battery compartment defined by the cover for receiving the rechargeable batteries, and a cable in electrical connection with the circuit board to electrically connect the rechargeable receiver to a personal computer wherein the rechargeable receiver can receive signals from a wireless transmitter of a peripheral device and can also recharge the rechargeable batteries from the wireless peripheral device.

### BACKGROUND-FIELD OF INVENTION

The present invention relates generally to wireless receivers for receiving signals transmitted from wireless devices. More specifically the present invention relates to a wireless receiver capable of recharging batteries and receiving signals transmitted from a computer peripheral such as a wireless mouse.

### BACKGROUND-DESCRIPTION OF RELATED ART

Besides the keyboard, the other main input peripheral for a personal computer is the mouse, a type of pointing and selecting device. The mouse is commonly connected to the personal computer with a small cable for transmitting the movement of the mouse and the pressing of the buttons on the mouse to the personal computer to control the personal computer. The cable also allows the mouse to receive and use the power from the personal computer.

As more peripherals are connected to the personal computer, more cables are used and less desktop spaces are available for each peripheral. The cables tend to tangle together and make maintenance and repair of the personal computer difficult. Furthermore, when the cable that connects the mouse to the personal computer is entangled with the other cables, the free movement of the mouse is restricted causing difficulty in the use of the mouse. The cables around the personal computer also take up valuable desktop spaces that the mouse requires for its movements.

A common solution to reduce or eliminate the cables around a personal computer is to use a wireless transmitter to transmit the signals from the peripherals to a remote receiver that connects to the personal computer with a cable. The cable that was required to connect the peripheral to the personal computer is eliminated and spaces are freed up around the personal computer that was previously taken up by the cables. The most common candidates for the wireless transmitter and remote receiver setup are the keyboard and the mouse.

However, since a wireless peripheral device does not connect to the computer directly with a cable it must have its own power source. The most common power source used for wireless transmitters is the battery. The battery may be non-rechargeable batteries such as alkaline batteries or rechargeable batteries that may be recharged and reused repeatedly.

As the power in the batteries is consumed, the batteries will require either replacement for non-rechargeable types or recharging for rechargeable types. For non-rechargeable batteries, a set of replacement batteries must be readily available near the wireless peripheral device for replacement when the need arises. For rechargeable batteries, a set of fully recharged batteries must be within easy reach of the wireless peripheral device for replacement or the rechargeable batteries must be taken out and placed into a recharger to be recharged. If either type of batteries are not readily available on hand to make an immediate exchange for the exhausted batteries in the wireless peripheral device, the wireless peripheral device will be rendered useless until a set of replacement batteries can be obtained.

Generally, the batteries used in these wireless peripheral devices are the AA or AAA size batteries. These batteries are small in size and are easily misplaced or lost. Rechargeable batteries will slowly discharge themselves if left unused for extended period of times. Therefore, often when the needs arise to require replacement of the batteries, either the replacement batteries cannot be found or the batteries are discharged and require several hours to recharge. During this time the wireless peripheral device is rendered useless and may prevent the use of the personal computer altogether.

### SUMMARY OF THE INVENTION

The present invention is a rechargeable receiver for receiving the signal from a wireless transmitter of a computer peripheral device such as a keyboard or a mouse. The rechargeable receiver has a built-in recharger for recharging the rechargeable batteries used in the computer peripheral device with the wireless transmitter.

The rechargeable receiver comprising a housing formed by the interface of a cover and a base to affix and enclose a circuit board with a signal receiver and a recharging circuit within the housing, a battery charger with a battery compartment defined by the cover for receiving the rechargeable batteries, and a cable in electrical connection with the circuit board to electrically connect the rechargeable receiver to a personal computer wherein the rechargeable receiver can receive signals from a wireless transmitter of a peripheral device and can also recharge the rechargeable batteries from the wireless peripheral device.

### BRIEF DESCRIPTION OF THE DRAWINGS

FIG. 1 shows the prior art wherein a mouse is connected directly to the personal computer with a cable.

FIG. 2 shows the prior art wherein a mouse with a wireless transmitter that transmits the signal to a remote receiver that is connected to the personal computer with a cable.

FIG. 3 shows the perspective view of the rechargeable receiver.

FIG. 4 shows the rechargeable receiver with its components.

FIG. 5 shows the top view of the rechargeable receiver with rechargeable batteries inserted in the battery compartment for recharging.

FIG. 6 shows the top view of the rechargeable receiver.

### DETAILED DESCRIPTION OF THE PREFERRED EMBODIMENT

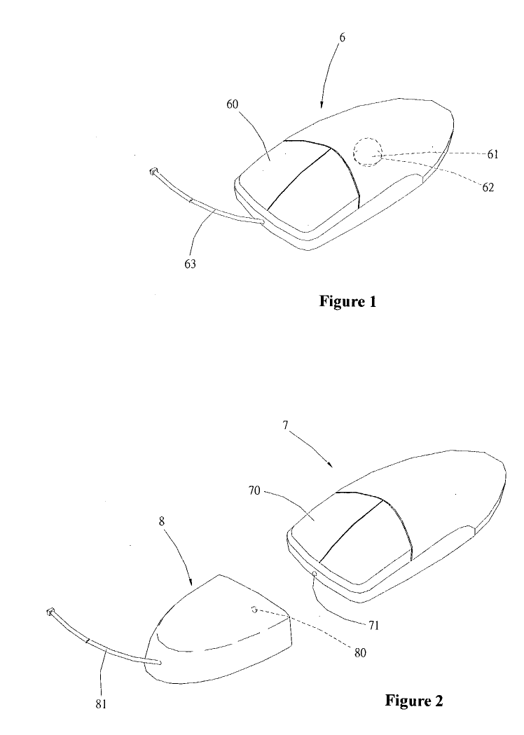

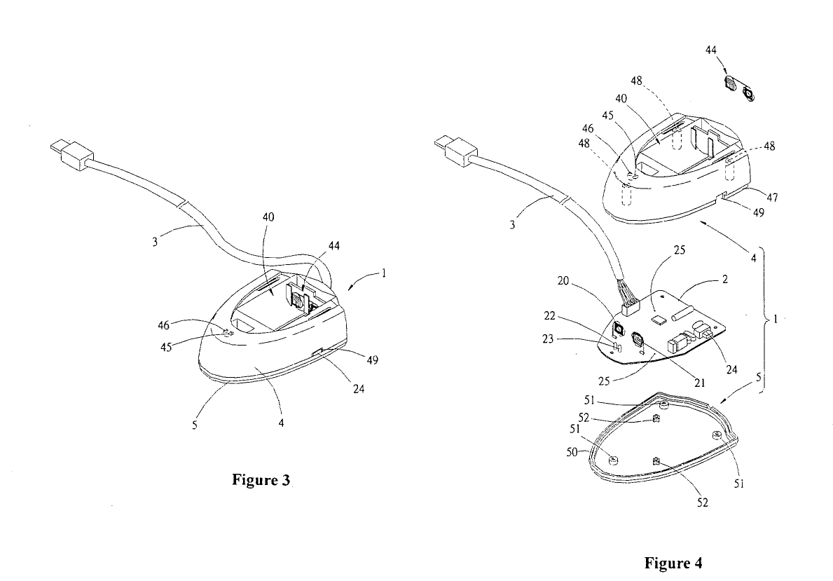

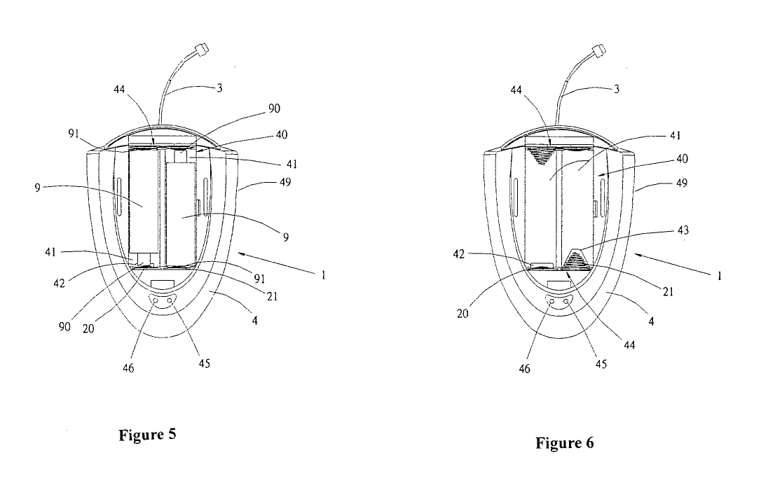

FIG. 1 shows the prior art where the mouse comprises of a housing 6 that has one or more buttons 60 and a track ball 61 that is partially exposed at the bottom of the housing 6 through an opening 62. The mouse is connected to a personal computer with a cable 63. The movement of the mouse on a flat surface will rotate the track ball 61 which is in connection with sensors that transmits the positioning signal to the computer through the cable 63.

FIG. 2 shows the prior art where the mouse comprises of a housing 7 that has one or more buttons 70 and a signal transmitter 71 that wirelessly transmits the signal to a signal receiver 80 in a receiver 8 which then transmits the signal to the computer through a cable 81.

The housing 1 of the rechargeable receiver comprises of a cover 4 and a base 5. A circuit board 2 is enclosed and affixed within the housing 1 and is connected to the personal computer through a cable 3.

The cover 4 defines a battery charger 40 with a battery compartment 41 with a positive contact hole 42 and a negative contact hole 43 and a connector 44. A charging status indicator hole 45 and a signal indicator hole 46 are defined at one end of the cover 4. An access hole 49 is defined by the protruding edge 47 at the bottom of the cover 4 for access to the frequency modulator 24 on the circuit board 2.

A positive contact 20 and a negative contact 21 are attached to the circuit board 2 for recharging the rechargeable batteries 9 in the battery compartment by electrically interfacing through the positive contact hole 42 and negative contact hole 43 with the positive terminal 90 and the negative terminal 91 of the rechargeable battery 9. A signal indicator 22 is affixed to the circuit board 2 to indicate receipt of the signal. A charging status indicator 23 is affixed to the circuit board 2 to indicate the charging status of the battery recharger 40. A frequency modulator 24 is affixed to the circuit board 2 to control and change the frequency of the signal.

The base 5 of the rechargeable receiver has a receiving edge 50 that interfaces with the protruding edge 47 at the bottom of the cover 4. Multiple screw holes 51 are provided in the base 5 that allows screws to be inserted through the screw holes 51 and through the circuit board 2 into screw sockets 48 affixed under the cover 4 to hold the cover 4 to the base 5. Multiple posts 52 protruding from the base 5 interface with locating holes 25 in the circuit board 2 to retain and affix the circuit board 2 within the housing 1.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A rechargeable receiver comprising:
a housing-with a battery compartment for receiving rechargeable batteries;
a circuit board affixed and enclosed within said housing with circuits to control the receipt and transfer of a wireless signal and the charging of the rechargeable batteries in the battery compartment; and
a cable electrically connected to the circuit board;
wherein the rechargeable receiver can receive a signal from a wireless transmitter and transmit that signal to a personal computer through the cable and wherein the rechargeable receiver can recharge rechargeable batteries in its battery compartment.

2. A rechargeable receiver according to claim 1, wherein a positive contact and a negative contact protrude from the circuit board into the battery compartment for recharging the rechargeable batteries in the battery compartment.

3. A rechargeable receiver according to claim 2, wherein the battery compartment has recesses for receiving two batteries and electrical connection for recharging by electrical contact with the positive contact and negative contact in said battery compartment.

4. A rechargeable receiver according to claim 1, wherein the housing further comprises of a cover attached to a base with screws.

5. A rechargeable receiver according to claim 1, wherein the circuit board has a signal indicator.

6. A rechargeable receiver according to claim 1, wherein the circuit board has a charging status indicator.

7. A rechargeable receiver according to claim 1, wherein the battery compartment is covered with a cover.
